(19) United States
(12) Patent Application Publication
(10) Pub. No.: US 2014/0291986 A1
(43) Pub. Date: Oct. 2, 2014

(54) Quick Connect Fitting Apparatus

(71) Applicant: RAMER PRODUCTS, INC., Niles, MI (US)

(72) Inventors: Andrew R. Racine, Stevensville, MI (US); Michael A. Mulinax, Edwardsburg, MI (US)

(73) Assignee: Ramer Products, Inc., Niles, MI (US)

(21) Appl. No.: 13/851,123

(22) Filed: Mar. 27, 2013

(51) Int. Cl. F16L 37/05

(52) U.S. Cl. CPC F16L 37/05
USPC 285/345

(57) ABSTRACT

A fitting for coupling of smooth wall tubes including an elongated body, a collet, a ram insert, a seal and a socket insert. The socket insert is positioned between the ram insert and the collet whereupon the socket provides an adjustment for the fitting so as to accommodate tubes having a range of diameter without user adjustment.

### BACKGROUND OF THE DISCLOSURE

1. Field of the Disclosure

The invention relates in general to a quick connect fitting, and more particularly, to a quick connect fitting that is generally useful for coupling smooth wall tubes. While not particularly limited thereto, such fittings are often utilized during leak testing and production leak testing and charging.

2. Background Art

The use of fittings, and, in particular quick connect fittings is known in the art.

Such fittings are often useful for coupling refrigeration lines for purposes of leak testing and charging.

Examples of prior art fittings are shown in U.S. Pat. No. 3,779,587 issued to Racine; U.S. Pat. No. 3,868,132 issued to Racine and U.S. Pat. No. 4,154,465 issued to Van Meter, the entirety of each of which are hereby incorporated by reference. These prior art fittings represented a dramatic improvement over the prior fittings in use prior thereto. For example, such fittings allowed for the quick coupling and decoupling of smooth wall tubes.

While the foregoing have been advantageous and continue to be in use today, there have been drawbacks. First, in many instances, such fittings include multiple components which increase cost and assembly time. In addition, other embodiments require outside adjustment to compensate for differences in the diameter of pipes. In some instances, seals can be compromised during such adjustments. Additionally, the adjustments themselves can be less than accurate and can lead to inadvertent failure or leaking of the fitting.

Thus, it would be advantageous to overcome the drawbacks of the foregoing fittings. For example, and not to be limited thereto, it would be advantageous to provide a fitting that can accommodate a wider range of tube diameters without user adjustment. It would be also be advantageous to provide a fitting with a simplified assembly which also facilitates ease of replacement of spares. Other advantages will be apparent in light of the disclosure below, and, the foregoing advantages are not to be deemed limiting, but solely exemplary in nature.

### SUMMARY OF THE DISCLOSURE

The disclosure is directed to a fitting comprising an elongated body, a collet, a ram insert, a seal, and a socket insert assembly. The elongated body has a first end and a second end. An inner passageway extends from the first end to the second end. An inside taper is proximate the first end. The first end of the body terminating at a body entry opening. The collet has a plurality of inwardly directable split collet members interfacing with the inside taper. Movement of the split collet members into contact with the taper directs inward movement of the split collet members.

The ram insert is slidably positionable within the inner passageway of the body. The ram insert has a ram socket at a first end opening toward the collet and a second end opposing the first end. The ram socket has a passageway providing fluid communication with the ram socket and providing for coupling to an outside supply which is spaced apart from the ram socket and the first end. Additionally, the ram socket has an inner wall with a reduced cross-section spaced apart from an outer edge thereof. The seal is positioned between the collet and the ram insert. The seal includes a passageway providing fluid communication between the passageway of the ram insert and the body entry opening.

The socket insert assembly is positioned between the seal and the ram insert. The socket insert assembly includes a passageway extending therethrough for fluid communication between the passageway of the seal and the ram insert. The socket insert assembly is positionable between an extended position and a refracted position, with a biasing member biasing the socket insert assembly in an extended position. Movement of the ram insert toward the collet upon insertion of a tube therethrough results in a tube overcoming the biasing member upon cessation of movement of the collet with continued movement of the ram insert.

In a preferred embodiment, the fitting further comprises a cam element pivotably coupled to the second end of the body. A cam surface engages the second end of the ram insert. Upon pivoting of the cam element, slidable movement of the ram insert within the inner passageway of the body is facilitated.

In a preferred embodiment, the cam element further includes a handle that extends away from the cam surface.

In another preferred embodiment, the cam element further includes a first cam surface and a second cam surface which is angularly disposed to the first cam surface. A line is defined therebetween.

In another preferred embodiment, the socket insert assembly comprises an outer cylindrical element and an inner cylindrical element slidably positionable within the outer cylindrical element. The two cylindrical elements extend between an extended position and a retracted position. The biasing member biases the inner cylindrical element relative to the outer cylindrical element in the extended position.

In another preferred embodiment, the outer cylindrical element further includes a first end and a second end. An inward flange is positioned at the first end and a flange has an inner surface which is positioned at the second end. The inner cylindrical element includes an outward flange at a second end thereof and a flange that has an inner surface at the first end thereof. The outward flange of the inner cylindrical element cooperates with the inward flange at the first end of the outer cylindrical element to define the extended orientation, which precludes further outward relative movement. The biasing member extends between the inner surface of the flange at the second end of the outer cylindrical element and the inner surface of the flange at the first end of the inner cylindrical element.

In another preferred embodiment, the flanges with which the biasing member interfaces extend outwardly from the cylindrical elements.

Preferably, the biasing member comprises a coil spring.

In another preferred embodiment, a seal washer is positioned between the inner seat of the collet and the seal.

Preferably, the body further includes a coupling slot and a lever slot opposite the coupling slot at the second end, the ram insert having a threaded bore in communication with the fluid passage, with the threaded bore being accessible through the coupling slot.

### BRIEF DESCRIPTION OF THE DRAWINGS

The disclosure will now be described with reference to the drawings wherein:

FIG. 1 of the drawings is a perspective view of an embodiment of the fitting of the present disclosure, showing the insertion of a smooth wall tube, and showing the cam element in the relaxed orientation, wherein the smooth wall tube can readily be inserted and removed;

FIG. 2 of the drawings is a cross-sectional view of the embodiment of the fitting of the present disclosure, taken generally about lines 2-2 of FIG. 1;

FIG. 3 of the drawings is a cross-sectional view of the embodiment of the fitting of the present disclosure, taken generally about lines 3-3 of FIG. 1;

FIG. 4 of the drawings is a perspective cross-sectional view of the embodiment of the fitting of the present disclosure taken generally about lines 2-2 of FIG. 1;

FIG. 5 of the drawings is a cross-sectional view of the body of the fitting of the present disclosure, taken generally about lines 2-2 of FIG. 1;

FIG. 6 of the drawings is a cross-sectional view of the ram insert of the fitting of the present disclosure, taken generally about lines 2-2 of FIG. 1;

FIG. 7 of the drawings is a perspective cross-sectional view of the socket insert subassembly of the fitting of the present disclosure, taken generally about lines 2-2 of FIG. 1;

FIG. 8 of the drawings is a cross-sectional view of the outer and inner cylindrical elements of the socket insert subassembly of the fitting of the present disclosure, taken generally about lines 2-2 of FIG. 1;

FIG. 9 of the drawings is a perspective view of the collet of the fitting of the present disclosure;

FIG. 10 of the drawings is a perspective cross-sectional view of the collet of the fitting of the present disclosure, taken generally about lines 2-2 of FIG. 1;

FIG. 11 of the drawings is a perspective view of the seal of the fitting of the present disclosure;

FIG. 12 of the drawings is a cross-sectional view of the seal of the fitting of the present disclosure taken generally about lines 2-2 of FIG. 1;

FIG. 13 of the drawings is a perspective view of the seal washer of the fitting of the present disclosure;

FIG. 14 of the drawings is a cross-sectional view of the seal washer of the fitting of the present disclosure, taken generally about lines 2-2 of FIG. 1;

FIG. 15 of the drawings is a perspective view of the cam element of the present disclosure;

FIG. 16 of the drawings is a side elevational view of the cam element of the present disclosure;

FIG. 17 of the drawings is a cross-sectional view of the fitting of the present disclosure, showing the cam element in the gripping orientation; and

FIG. 18 of the drawings is a partial cross-sectional view of the fitting of the present disclosure, in the configuration of FIG. 17, showing the compression of the seal.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

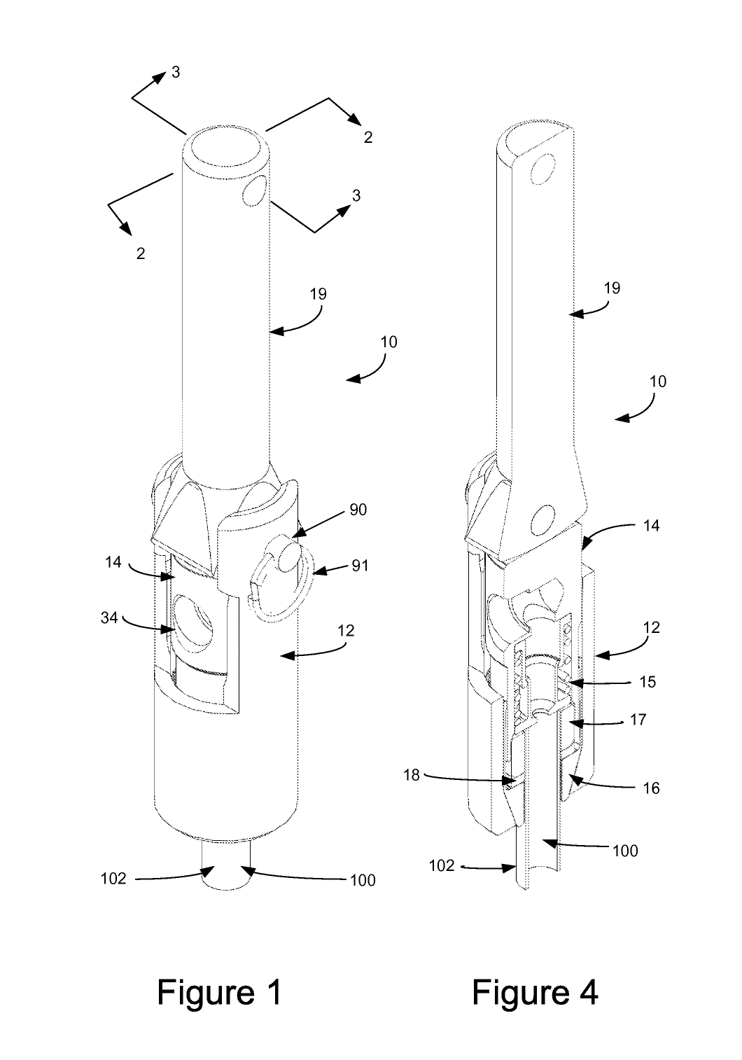

Referring now to the drawings and in particular to FIGS. 1 and 4, the fitting is shown generally at 10. The fitting 10 includes body 12, ram insert 14, socket insert subassembly 15 (FIG. 4), collet 16, seal 17, seal washer 18 and cam element 19. It will be understood that the fitting is configured to provide coupling between a smooth wall tube, such as smooth wall tube 100, and a tube that is attached to the threaded bore 34 of the ram insert 14. Often, such fittings are useful for leak testing of, for example, refrigeration systems. While it will be understood that the disclosure is not limited to such use, and, a number of different uses are contemplated for use. While contemplated for use with a number of different tubes, it is contemplated that the tubes with which the fitting is utilized range from 0.08 inches to approximately an inch. Of course, the foregoing is for illustrative purposes, and is not to be limited thereto.

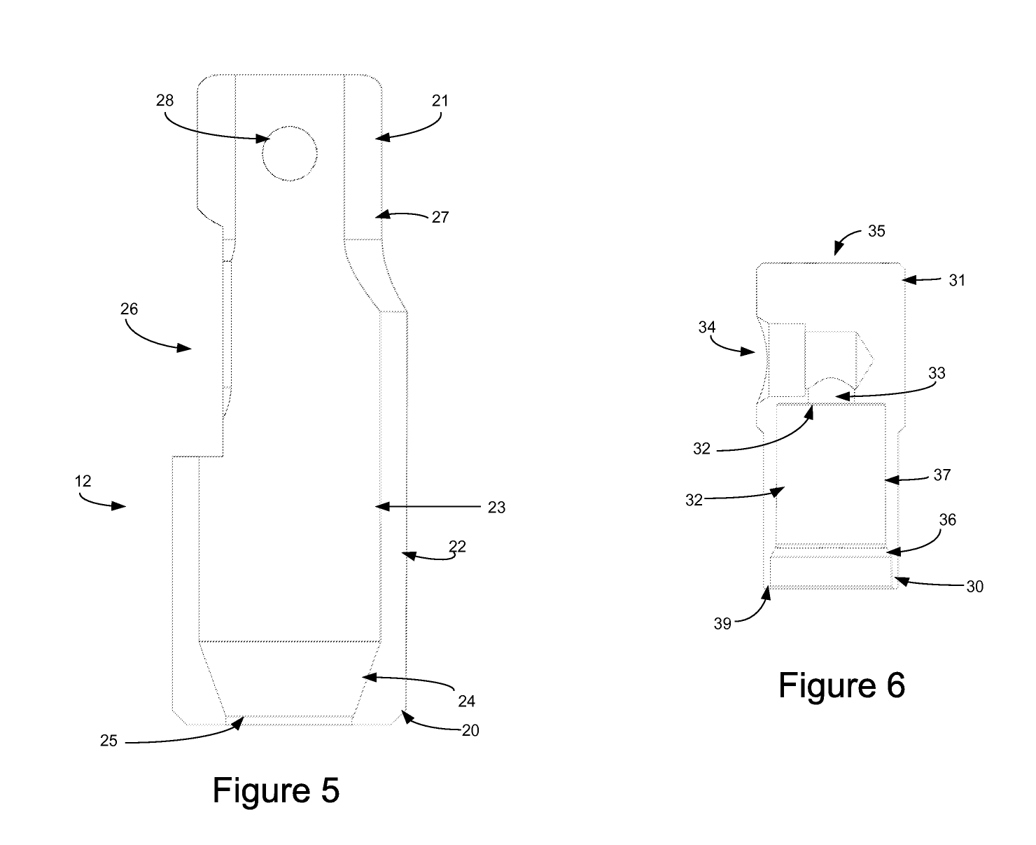

The body 12 is shown operably in FIGS. 1-4 and in more detail in FIG. 5 as comprising an elongated member having a first end 20, second end 21, outer surface 22 and inner passageway 23. The inner passageway defines a body entry opening 25 at the first end 20 of the body. The inner passageway further includes an inside taper 24 proximate the body entry opening 25. A coupling slot 26 is defined at the second end of the body 12 and provides communication with the inner passageway 23. Opposing the coupling slot is a lever slot 27 which also provides communication with the inner passageway 23. A pair of pin openings 28 provides an opening through which drive in 90 can be extended. Generally, the body is substantially circular in cross-section, although not limited thereto. The cross-section is substantially uniform in diameter (tapering at the inside taper 24).

With reference to FIGS. 1 through 6, it will be understood that the coupling slot 26 provides access to the threaded bore 34 of the ram insert 14. The lever slot 27 allows for the range of movement of the handle 80 of the cam element 19. The body 12 comprises a metal member, such as stainless steel, titanium, aluminum. The surfaces may be polished or coated or otherwise treated to enhance sealing ability and to enhance durability. The disclosure is not limited to any particular material specification. In addition, it will be understood that the dimensions of the body can be altered depending on the dimensions of the smooth wall tube. It will also be understood that the device is configured for use with a range of dimensions of smooth wall tube, and has some variability in the tubes that successfully work with a single dimensioned device.

The ram insert 14 is shown operatively in FIGS. 1-4, and in greater detail in FIG. 6. The ram insert includes first end 30, second end 31, ram socket 32, fluid passage 33 and threaded bore 34. The ram socket 32 opens toward the second end and defines outer seat 36, inner wall 37, outer edge 39 and bottom wall 38. The seat 36 is spaced apart from the outer edge 39 which comprises a step down in diameter of the ram socket 32. Generally, the ram is circular in configuration and slides freely within the inner passageway 23 of the body 12 between the first end and the second end of the body. A ram face 35 is positioned at the second end 31 of the ram insert 14. The ram face, as will be explained interfaces with the cam surface 81 of the cam element 19.

The fluid passage 33 extends from the bottom wall 38 and is in fluid communication with the ram socket 32. The threaded bore 34 is generally normal to the fluid passage 33 and is in fluid communication therewith. It will be understood that the threaded bore 34 is configured to receive an outside connection with a threaded tube or coupling. It will be understood that in the place of a threaded bore, another type of coupling may be contemplated, such as a quick connect fitting, an interference fit or the like. In addition, it is contemplated that a tube may be permanently coupled to the ram insert 14, thereby moving the coupling to a location removed from the ram insert 14.

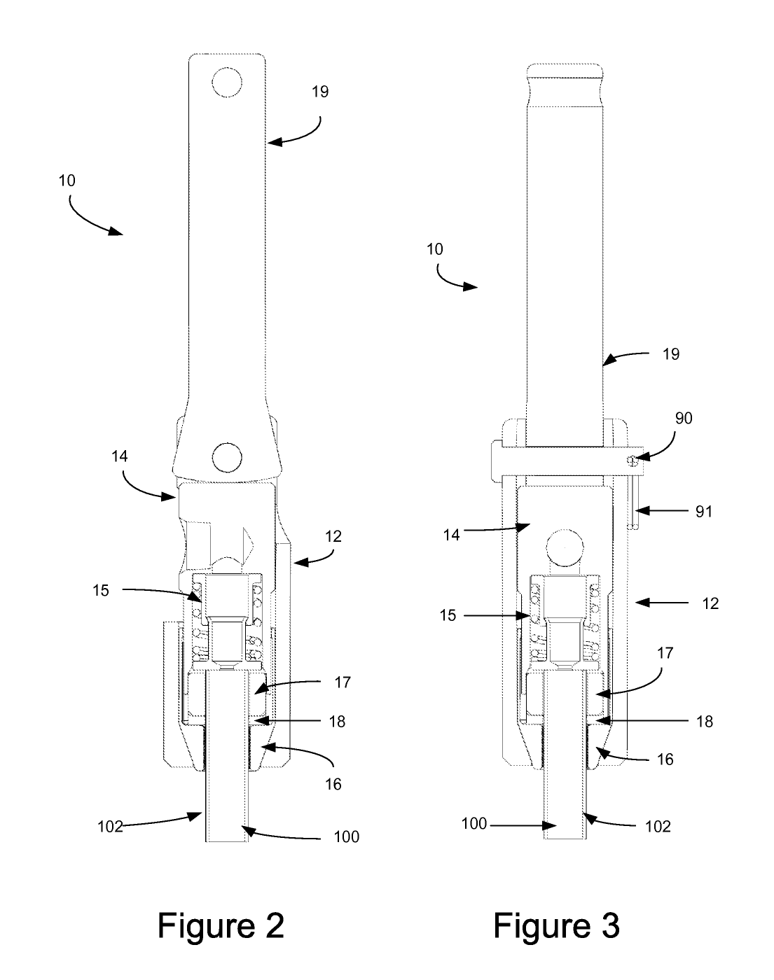

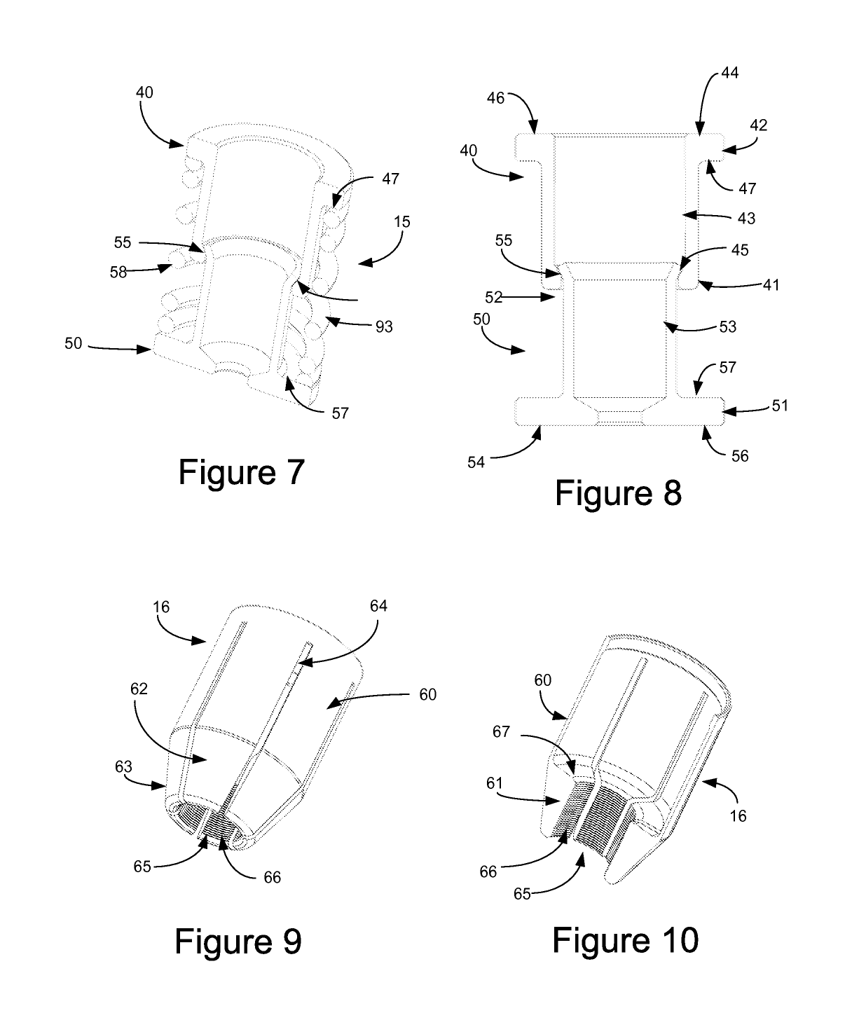

The socket insert 15 is shown operatively in FIGS. 2-4, and in greater detail in FIGS. 7 and 8 as comprising outer cylindrical element 40, inner cylindrical element 50 and biasing member 58. The socket insert 15 is positioned within the ram socket 32 of the ram inset 14, wherein the socket insert is slidably positionable therein. The outer cylindrical element 40 includes a first end 41, second end 42, inner bore 43 and flange 44. The inner bore 43 terminates at inward taper 45 which is positioned at the first end 41, and defines an opening. The flange 44 extends outwardly and is positioned at the second end 42 and includes an outer surface 46 and an inner surface 47.

The inner cylindrical element 50 includes first end 51, second end 52, inner bore 53 and flange 54. The inner bore 53 includes outward flange 55 at the first end thereof, and the inner bore 53 defines an opening. Additionally, flange 54 includes outer surface 56 and inner surface 57 and substantially corresponds to the flange 44 of the outer cylindrical element.

The inner cylindrical element 50 slides within the outer cylindrical element 40, in a piston and cylinder fashion (i.e., with the inner cylindrical element telescopically sliding within and relative to the outer cylindrical element) with the openings being in fluid communication throughout. Eventually, if travel continues, the inner surface 57 of the flange 54 engages the first end 41 of the outer cylindrical element 40, precluding further inward movement. This position represents the fully compact or fully retracted orientation. Similarly, movement in the opposing direction eventually engages the outward flange 55 of the inner cylindrical element 50 with the taper 45 of the outer cylindrical element 40 to preclude further slidable movement. The second position represents the fully extended orientation. Generally, any position between the retracted orientation and the extended orientation is facilitated.

Biasing member 58 is shown in FIG. 7 as comprising coil spring 93. The coil spring has a first end that engages the inner surface 57 of the flange 54 and a second end that engages the inner surface 47 of the flange 44. The spring is configured to apply an outward force in an effort to drive the outward flange 55 and the taper 45 toward each other, so as to achieve the fully extended orientation. The particular configuration of the spring (i.e., the spring constant, and the like) can be varied depending on the application. Of course, other biasing members are contemplated, including, but not limited to other spring configurations.

Collet 16 is shown operatively in FIGS. 2-4 and in greater detail in FIGS. 9 and 10 as comprising body 60 which terminates in a cone end 63. A plurality of slits 64 are spaced axially around the body so as to define a plurality of split collet members 61. The slits 64 extend from the cone end 63 toward the opposing end, but stop short of the end itself so as to define a ring with a plurality of split collet members extending therefrom. Each of the split collet members 61 includes an inner surface 65 which includes gripping elements 66 (in the embodiment shown, such gripping elements comprise serrations). The ring and the split collet members together define a collet passageway which includes an inner seat 67. It will be understood that by varying the dimensions and thickness of the materials, the force with which the split collet members are deflected can be varied.

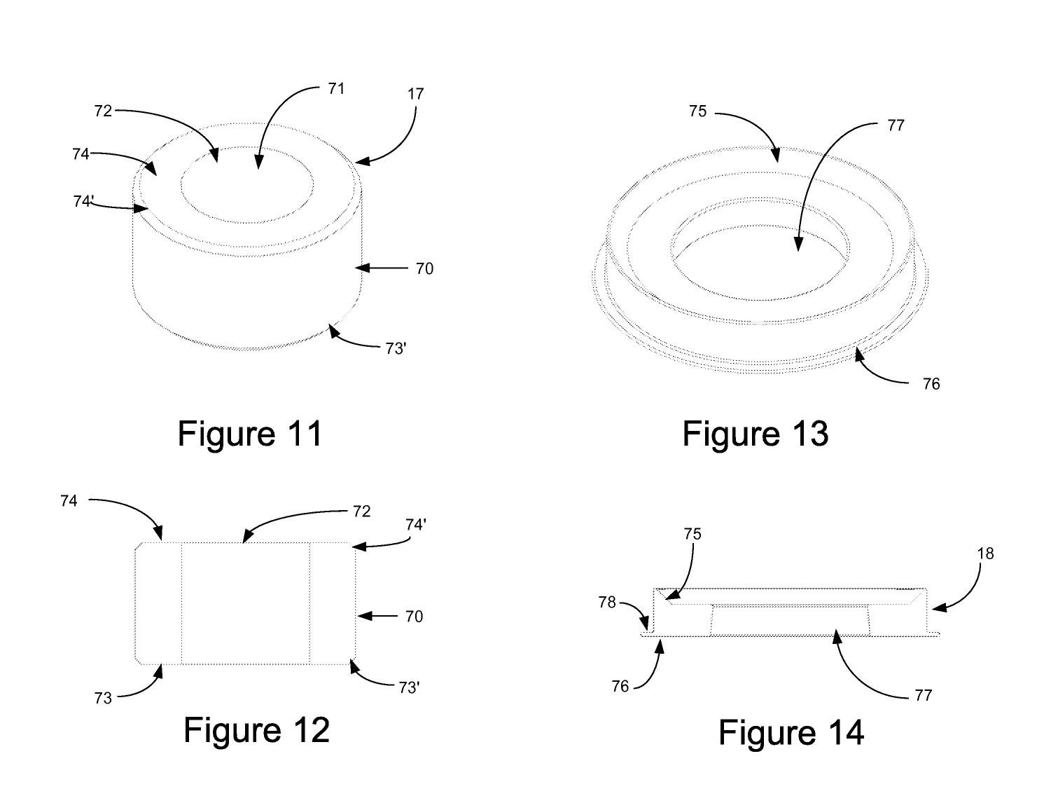

Seal 17 is shown operatively in FIGS. 2 and 3, and in greater detail in FIGS. 11 and 12 as comprising outer surface 70, inner surface 71 which together define passageway 72. The outer surface 70 includes first seal surface 73 with tapered edge 73′ and second seal surface 74 with tapered edge 74′. The seal 17 comprises a substantially ring-like seal member with outer tapers at each of the upper corner and the lower corner thereof. The passageway 72, as will be explained, corresponds to the body entry opening and the fluid passageway 33 of the ram insert 14. Generally, seal 17 comprises a flexible polymer member, such as a rubber or the like. Of course, the disclosure is not limited to any particular material, and a number of materials are contemplated as long as performance parameters are met by such materials.

Seal washer 18 is shown operatively in FIGS. 2-4 and in greater detail in FIG. 14 as comprising inner seat 75, outer seat 76 an passageway 77 and with flange 78. Generally, the seal washer comprises a metal member which provides a rigid shape mating configuration to the second seal surface 74. The outer edge of the inner seat includes a raised ridge that corresponds to tapered edge 73′. The outer seat extends further than the inner seat to define outer flange 78.

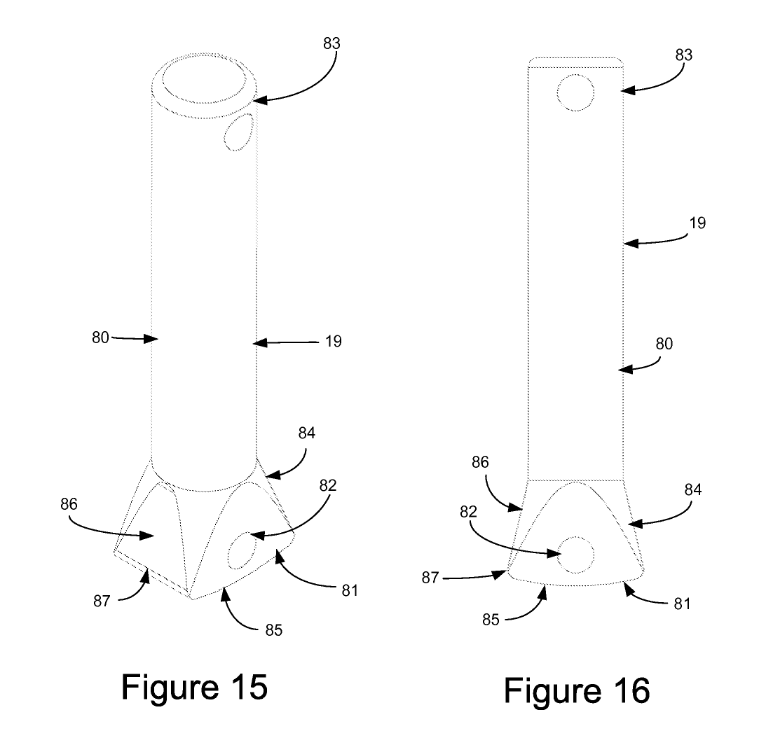

The cam element 19 is shown operatively in FIGS. 1-4 and in more detail in FIGS. 15 and 16 as comprising handle 80, cam surface 81 and pivot opening 82. The handle 80 includes a distal end 83 and a proximal end 84. The cam surface is positioned at the proximal end of the handle 80, as is the pivot opening 82 which extends therethrough, in a direction perpendicular to the intended pivoting of the handle 80, so as to provide the axis of rotation therefor. The cam surface comprises a first region 85 which is generally arcuate and a second region 86 which is angularly disposed thereto at approximately a right angle (while other angles are likewise contemplated) such that the two meet at line 87. Such a configuration, as will be explained serves to lock the handle in the orientation defined by the interface between the ram face 35 and the second region 86.

To assemble the fitting 10, the body 12 is first provided. It will be understood that there are a number of different orders in which the different components can be assembled. Thus, a single method of assembly will be described with the understanding that any number of variations to the steps and to the order of the steps is contemplated.

More specifically, the collet 16 is slid into the body so that the gripping elements 66 engage the inside taper 24 and rest thereagainst. It will be understood that the conical configuration of the collet members corresponds to the inside taper 24 of the inner passageway 23 of the body 12.

The seal washer can be positioned so that the outer seat 76 is in abutting engagement with the inner seat 67 of the collet. Once in position, the seal can be positioned so that the first seal surface 73 engages the inner seat 75 of the seal washer 18. The seal and the seal washer can be assembled first and positioned on the collet, wherein the three structures can be introduced simultaneously. In other assembly methods, the seal and seal washer (and collet) can be assembled onto the ram insert and introduced into the body as a single unit.

To assemble the ram insert 14, the socket insert subassembly is first provided. Generally, the outer cylindrical members with the biasing member are provided as a unit. It will be understood that the outer and inner cylindrical elements are first joined together wherein the outward flange is pressed outwardly so that it is locked from removal by the inner cylindrical element.

The socket insert subassembly is placed within the ram socket 32, and in particular, the second end of the outer cylindrical element is positioned so as to abuttingly engage the bottom wall 38 of the ram socket 32. Once the socket insert assembly is in position, the ram insert is directed into the inner passageway 23 of the body 12 with the first end of the ram insert 14 directed toward the body entry opening 25.

Once the socket insert assembly has been coupled to the ram insert, the two are directed into the inner passageway 23 of the body 12. The outer seat 36, upon insertion abuttingly engages the outer surface 70 of the seal 17 and is configured to sealingly engage the same. The socket insert assembly is rotated so that the threaded bore 34 is positioned within the coupling slot 26 and freely accessible. It will be understood that an outside line can be coupled to the threaded bore after insertion of the same within the body, or, alternatively, prior to assembly.

Once the ram insert 14 has been positioned, the cam element is coupled to the body. In particular, the cam element 19 is positioned so that the cam surface 81 abuttingly engages the ram face 35 of the ram insert 14. The cam element is generally oriented so as to be substantially collinear with the body 12, and is translated until the pivot opening 82 corresponds to the pin openings 28. At such time, the drive pin 90 is extended through all of the openings to pivotably couple these structures relative to each other. Finally, the locking member 91 is coupled to the drive pin to preclude the drive pin from reversing out of the openings. The fitting 10 is fully assembled and ready for use.

In operation, the user first insures that the handle 80 of the cam element 19 extends substantially directly out of the body 12 and generally collinearly with the body. This configuration is the relaxed orientation, and is shown in FIGS. 1 through 4. In such a configuration, the collet is expanded generally to an equilibrium retracted position. The tube 100 can be inserted into the collet passageway 65. Generally, the tube 100 is inserted until the end of the tube abuts the first end 51 of the inner cylindrical element 50. It will be understood that in the relaxed orientation, the socket insert subassembly is in the extended orientation.

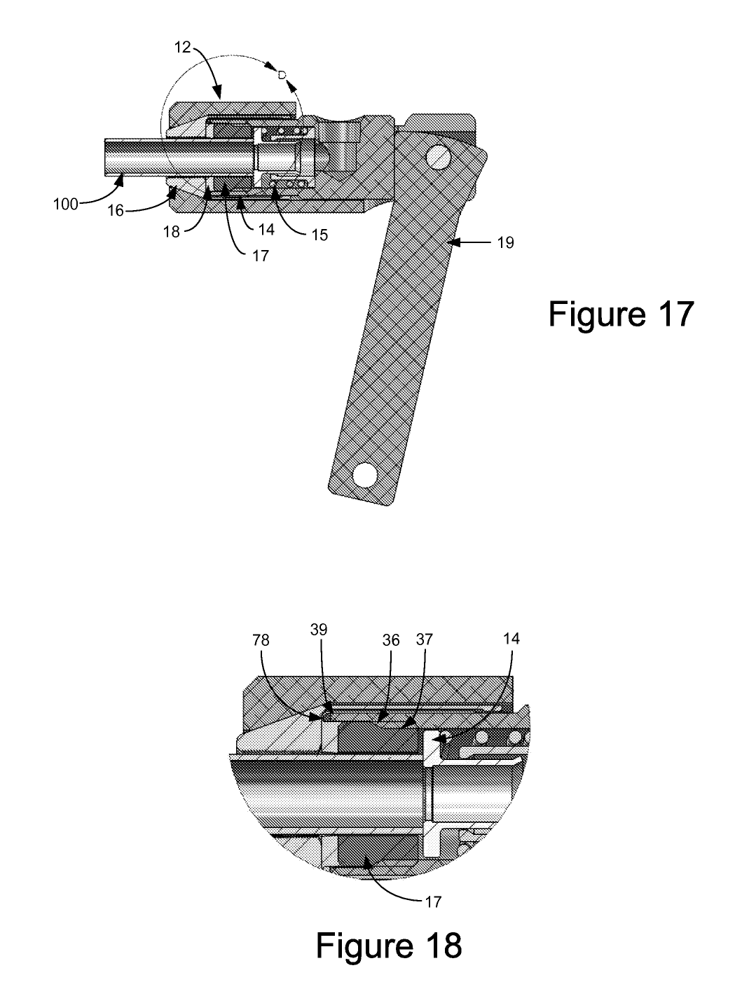

Once the tube is in the proper position, the cam element is actuated into the configuration shown in FIGS. 17 and 18, the gripping orientation. In particular, the handle element is pivoted about the drive pin 90. Initially, the cam surface 81 forces against the ram face 35 directing the ram insert 14 toward the first end of the body 12. As the handle is further rotated, the ram insert is forced against the seal 17, the seal washer 18 and the collet 16. This directs the collet against the inside taper 24 of the body 12, which forces the split collet members 61 toward the tube so as to clamp against the same.

As the split collet members 61 have fully clamped against the tube 100, further rotation of the collar compresses directs the ram insert 14 toward the outer flange 78 of the seal washer and toward the second end of the body. Such movement directs the seal against the inner seat 75 and across the inner wall 37 of the ram socket 32 and the outer seat 36, which inwardly compresses the seal against the tube. With the ram insert moving toward the second end, to maintain the pipe position relative to the collet and the body, the pipe overcomes the biasing member 58 and compresses the socket insert subassembly by telescoping the inner cylindrical element into the outer cylindrical member.

The foregoing is shown in detail in FIG. 18. In particular, the seal is shown as being compressed inwardly by the reduction in diameter of the ram socket at the outer seat 36. In addition, the seal is compressed against the inner seat of the seal washer.

Eventually, the handle member is pivoted until the handle member is resting within the lever slot 27 of the body. Generally, such rotation is at least 90°, although it is contemplated that the rotation may be greater or less than 90°, and will primarily depend on the configuration of the cam. Advantageously, the lever slot 27 can form a natural stop for the handle member, as can the configuration of the cam surface itself. For example, the line 87 of the cam surface forms a natural lock as an increased force against the ram insert is required to move the handle member beyond the line 87. It will be understood that the handle can, in the embodiment shown, be pivoted in either direction.

In such an orientation, tube 100 is clamped and retained by the collet, and, additionally, the seal is strongly compressed against the outside of the tube, as well as the seal washer and the inner wall of the ram socket. It is contemplated that such an airtight seal will be maintained at pressures in excess of 2000 psi and a vacuum of down to 10 microns. Of course, other configurations may maintain an airtight seal for greater or lesser pressures and vacuum pulls, and the pressure and vacuum readings shown are for exemplary purposes only.

Significantly, the inward movement of the split collet members is directly related to the diameter of the tube. Inasmuch as the cam element directs the ram insert toward the first end a predetermined amount, the socket insert assembly provides an internal automatic adjustment, facilitating the retention of tubes of varying diameters, while insuring that the seal effectively maintains an effective seal, and the collet maintains sufficient grasp of the tube. In more detail, the smaller the diameter of the tube, the further inward the split collet members extend into the body entry opening, and the smaller the collet passageway. Conversely, the larger the diameter, the less inward movement of the split collet members. As the ram insert moves the same distance regardless of tube size, the larger the tube, the less movement of the collet. To compensate for the additional required movement of the ram insert, the collet and seal washer form a hard stop on one side of the socket insert and the ram insert forms a hard stop on the other side of the socket insert. Thus, any further movement of one relative to the other overcomes the biasing member and telescopically directs the outer and inner cylindrical elements toward the retracted orientation.

The overcoming of the biasing member occurs when the collet member has engaged the tube with sufficient force that further movement is precluded, and wherein the ram insert has not yet reached the end of travel that is dictated by the cam element. The amount of movement of the inner and outer cylindrical elements relative to each other is determined primarily by the diameter of the tube. In short, the socket insert subassembly serves as a means by which to automatically compensate for tubes of different diameters.

Advantageously, the configuration of the seal and the collet provides means for maintaining engagement of the smooth wall tube which resists rotation of the handle upon pressurization, and which maintains engagement of the smooth wall tube in the event that the handle is inadvertent rotated away from the gripping orientation. Such means are referred to herein as a pressure-assist safety feature. After the fitting is attached and pressurized, the pressure inside the connector advances the seal forward away from the ram insert. The pressurization, and ensuing movement action increases collet and seal compression. This seal compression makes the handle extremely difficult to release while under pressure. Even in the event that a user/operator is successful in releasing the handle while under pressure, the flexible collet will continue to hold the connector on the tube end (while the fitting will leak, generally, the fitting will resist releasing from the smooth wall tube).

When it is desired that the tube is released from the fitting, the pressure is first released. Once the pressure has ceased, the handle can be rotated back to the initial orientation wherein the handle is substantially collinear with the body. As the handle is rotated, the socket insert subassembly returns to the extended orientation, the seal is relaxed and the collet naturally returns toward the original configuration. The return of the collet expands the collet passageway 65, thereby releasing the tube. The tube can then be removed from within the fitting.

In the event that the seal member, or another part, is compromised, or broken, removal of the drive pin 90 allows for the removal of the handle. Once the handle is removed, all of the internal components merely slide out from within the internal passageway 23 of the body. As it is preferred that the components are separable (i.e., not coupled to each other within the body), any of the components that require replacement can easily be replaced.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A fitting comprising:
an elongated body having a first end and a second end, an inner passageway extends from the first end to the second end, with an inside taper proximate the first end, with the first end terminating at a body entry opening;
a collet having inwardly directable split collet members interfacing with the inside taper, whereupon movement of the split collet members into contact with the taper directs inward movement of the split collet members;
a ram insert slidably positionable within the inner passageway of the body, the ram insert having a ram socket at a first end opening toward the collet and a second end opposing the first end, the ram socket having a passageway providing fluid communication with the ram socket and providing for coupling to an outside supply which is spaced apart from the ram socket and the first end, the ram socket having an inner wall with a reduced cross-section spaced apart from an outer edge thereof;
a seal positioned between the collet and the ram insert, the seal including a passageway providing fluid communication between the passageway of the ram insert and the body entry opening; and
a socket insert assembly positioned between the seal and the ram insert, the socket insert assembly including a passageway extending therethrough for fluid communication between the passageway of the seal and the ram insert, the socket insert assembly positionable between an extended position and a retracted position, with a biasing member biasing the socket insert assembly in an extended position, whereupon movement of the ram insert toward the collet upon insertion of a tube therethrough results in a tube overcoming the biasing member upon cessation of movement of the collet with continued movement of the ram insert.

2. The fitting of claim 1 further comprising a cam element pivotably coupled to the second end of the body, and including a cam surface engaging the second end of the ram insert, whereupon pivoting of the cam element imparts slidable movement of the ram insert within the inner passageway of the body.

3. The fitting of claim 2 wherein the cam element further includes a handle that extends away from the cam surface.

4. The fitting of claim 2 wherein the cam element further includes a first cam surface and a second cam surface which is angularly disposed to the first cam surface, thereby defining a line therebetween.

5. The fitting of claim 1 wherein the socket insert assembly comprises an outer cylindrical element and an inner cylindrical element slidably positionable within the outer cylindrical element, between an extended position and a retracted position, with the biasing member biasing the inner cylindrical element relative to the outer cylindrical element in the extended position.

6. The fitting of claim 5 wherein the outer cylindrical element further includes a first end and a second end, an inward flange at the first end and a flange having an inner surface at the second end, the inner cylindrical element including an outward flange at a second end thereof and a flange having an inner surface at the first end thereof, the outward flange of the inner cylindrical element cooperating with the inward flange at the first end of the outer cylindrical element to define the extended orientation, thereby precluding further outward relative movement, and wherein the biasing member extends between the inner surface of the flange at the second end of the outer cylindrical element and the inner surface of the flange at the first end of the inner cylindrical element.

7. The fitting of claim 6 wherein the flanges with which the biasing member interfaces extend outwardly from the cylindrical elements.

8. The fitting of claim 6 wherein the biasing member comprises a coil spring.

9. The fitting of claim 1 wherein a seal washer is positioned between the inner seat of the collet and the seal.

10. The fitting of claim 1 wherein the body further includes a coupling slot and a lever slot opposite the coupling slot at the second end, the ram insert having a threaded bore in communication with the fluid passage, with the threaded bore being accessible through the coupling slot.
